(19) United States
(12) Patent Application Publication
(10) Pub. No.: US 2002/0042883 A1
(43) Pub. Date: Apr. 11, 2002

(54) Method and system for controlling access by clients to servers over an internet protocol network

(75) Inventors: Peter Terence Roux, Winchester (GB); Mark Richard Shorter, Ashtead (GB)

Correspondence Address: Pepper Hamilton LLP, 600 Fourteenth Street, N.W., Washington, DC, 20005, US

(73) Assignee: Soundvoice Limited

(21) Appl. No.: 09/814,095

(22) Filed: Mar. 22, 2001

Related U.S. Application Data
(63) Continuation-in-part of application No. 09/678,804, filed on Oct. 4, 2000.

(51) Int. Cl. H04L 9/00

(52) U.S. Cl. 713/201; 709/227

(57) ABSTRACT

A method of providing secure access to a target server by a client apparatus over an IP network comprises receiving an IP request from the client apparatus destined for the target server, sending a request for authentication information to the client, receiving the requested authenticated information, performing a validation process for the authentication information, and passing on the IP request from the client to the target server and returning data from the target server to the client dependent upon the outcome of the validation process.

The present invention generally relates to a method and system for controlling access by clients to servers over an Internet Protocol network to which authorised persons can gain access. In particular the present invention relates to a method and system for authenticating Internet Protocol requests by clients for access to data at servers by performing authentication at the Internet Protocol level.

The use of the Internet as a means of communicating electronically has become prolific The protocol used by the Internet for communications is the Internet Protocol (a level 3 protocol). The Internet Protocol is used as a protocol for carrying all of the types of protocols for providing the various services available over the Internet. For example, the Hyper Text Transfer Protocol (HTTP) is the protocol used for the World Wide Web. The File Transfer Protocol (FTP) is a commonly used protocol for the transfer of files over the Internet. The Simple Mail Transfer Protocol (SMTP) or the Post Office Protocol (POP) is the protocol used for the transfer of e-mails over the Internet. An emerging protocol which has received a great deal of interest recently is Voice over IP (VoIP) enabling the IP protocol to carry telecommunications speech traffic in data packets. Internet Protocol packets carry data for all of these protocols using the Internet Protocol. The Internet Protocol is also used much more broadly than just for the Internet. The Internet Protocol is used in Local Area Networks (LANs), Extranets, and Intranets. The protocol is further used in wireless communications such as the Bluetooth (trademark) and the new GPRS and Third Generation (G3) cellular mobile telephone systems. The Internet Protocol has become widely accepted as the standard protocol for routing packets and can be supported by any lower level physical layer and link level protocols (layer 1 and 2).

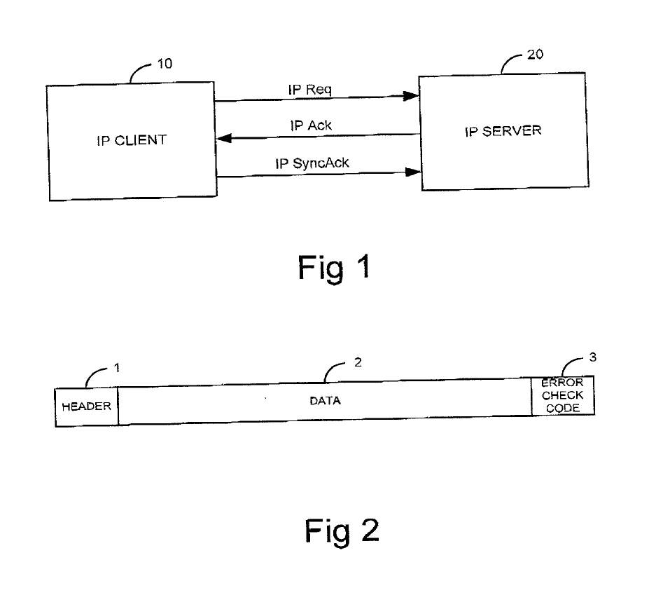

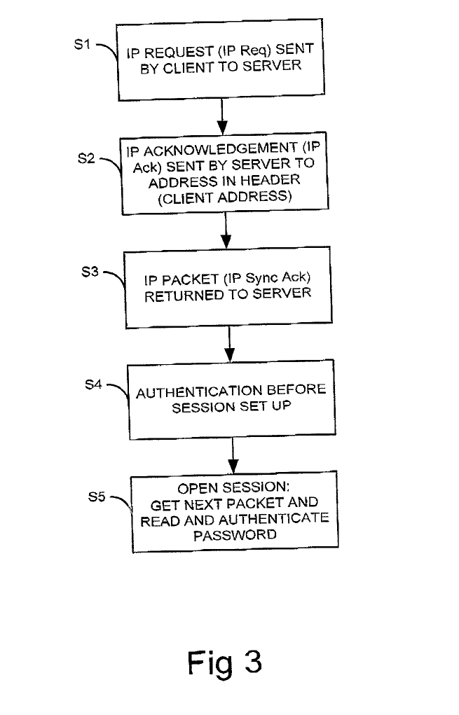

In order for a data to be transferred using any one of the higher level protocols, an Internet Protocol session must first be established. The schematic diagram of FIG. 1 and flow diagram of FIG. 3 illustrate this process. An application such as a web browser, FTP client or e-mail application running on the Internet Protocol client 10 generates an Internet Protocol request. The request provides an Internet Protocol data packet or packets as illustrated in FIG. 2. The Internet Protocol data packet comprises a header section 1, a data pay load 2 and an error check code section 3. The data 2 comprises a HTTP, FTP, SMTP or POP request or data. The header 1 carries information used for routing the Internet Protocol (IP) packet across the Internet. The header 1 thus contains the destination and source IP address for the packet. When the IP request is generated by the IP client 10 it is generated to give the domain name of the destination server. The IP client 10 will direct the packet to an access server providing access to the Internet. The packet will then be directed to a domain name server (DNS) that will look up the IP address for the target server using the domain name. The IP address is typically a twelve digit number e.g. 124.121.121.156,

With the IP address of the target server now determined the IP packet is routed over the Internet to the target IP server 20 (step S1). The IP server 20 responds by sending an IP acknowledgement to the IP address of the IP client 10 determined from the header 1 of the IP packet (step S2). When the IP client 10 receives the IP acknowledgement it returns an IP synchronisation acknowledgement to the IP server 20, (step S3).

If the IP server 20 is provided with a firewall, it can look at the IP address of the IP client and authenticate the IP session on the basis of the IP address (step S4). If the IP address is a valid IP address, the session is authenticated and set up. The payload of the IP packet and subsequent packets can then be read by the IP server to perform the next level of authentication such as reading a user name and password carried by the higher level protocol e.g. HTTP.

The problem with this prior art technique of authenticating access by a client to a server is that hackers can easily spoof the client's IP address as being an authentic IP address.

Thus a hacker is able to set up an Authenticated Transmission Control Protocol/Internet Protocol (TCP/IP) session This has two disadvantages, namely:

1) A server typically has a limited number of IP sessions that it can handle and a hacker can therefore overload the server.

2) Relying upon the authentication technique of the high level protocols is less secure since typically for example for HTTP, CGI scripts have to be run on the Web server to process the data. These can have programme errors which a hacker can find their way around whilst the IP session is open.

It is thus an object of the present invention to provide a more secure authentication process for allowing access to a server by a client over an Internet Protocol network.

The present invention thus provides a method and system in which an Internet Protocol request that is predestined for a target server is generated from a client apparatus and received at an intermediate security server. Upon receipt of the request the security server sends a request for authentication information to the client. If he client responds with authentication information the validation process is performed on the authentication information to authenticate the client or the user of the client. If the client or user is successfully authenticated, the Internet Protocol request from the client destined to a target server is transparently passed via the security server to the target server and data from the target server is returned to the client.

If no authentication information is received within a predetermined period of time or the authentication process is unsuccessful, the security server returns a default response to the client. This default response can simply be a message that the requested data is not available or not accessible, or it can comprise default data such as a web page or instructions for a web browser to load a particular web page. This latter option is preferred for the implementation of the present invention as a web security server since it is not immediately apparent to a person trying to gain authorised access that they have been denied access to the target server.

The present invention is applicable to any communications system using the Internet Protocol, including the Internet, Extranets, Intranets, Local Area Networks, and wireless networks such as Bluetooth (trademark) and cellular communications. The type of physical layer and level 2 protocol used is not important.

In the present invention, the term client encompasses and module that makes an Internet Protocol request and the term server encompasses any module that receives an Internet Protocol request and responds. The modules can be an apparatus or a program (application) implemented in a programmable device. The apparatus or programmable device can comprise any Internet Protocol enabled device such as computer, a personal digital assistant, a mobile device or telephone, or even any consumer device that is IP enabled such as a television, a refrigerator, or a washing machine. As is known to a skilled person in the art, apparatus operating a server can also operate a client and the client and the server can share program code.

In one embodiment the process of requesting and receiving the authentication information comprises returning the IP acknowledgment signal from the security server client and receiving an IP acknowledgement from the client at the security server which includes an identifier identifying that the client may be authorised to access the target server. The client includes a particular functionality enabling it to modify the returned IP acknowledgement in a particular way that is recognisable by the security server. The security server then sends an IP request for the authentication information to the client and the client responds with an IP acknowledgement comprising an IP packet containing the authentication information.

In a preferred embodiment of the present invention the authentication process takes place on a remote secure server. The security server, when it receives the authentication information, passes this together with a validation request to the secure server. The secure server performs a validation check using the authentication information and returns a validation response to the security server that acts upon the response to either pass on the IP request from the client to the target server or return a default response to the client.

In one embodiment the secure server includes a database of authorised users. The authentication information is compared to the database to determine whether the user is authorised. The database also includes a database of potential users. If the validation procedure is unsuccessful, the received authentication information is entered in the potential users database. This enables an administrator to access the database and transfer a user from the potential users database to the valid users database to enable the user to access the target server next time. This is particularly useful since it enables a user to make an initial attempt to access the target server and this is recorded at the secure server. An administrator can detect this first attempt and allow a user to access the target server subsequently by transferring the authentication information from the potential user's database to the valid user's database.

In the present invention, public access can only be gained to the security server. The security server is thus preferably given an Internet Protocol address that is a class A or class B address. The secure server and the target server have class A Internet Protocol addresses which are only usable over local area networks thus preventing direct public access to these servers.

In the embodiment of the present invention, the authentication information provided from the client can comprise information uniquely identifying the hardware and/or software configuration of the client machine, an electronically generated serial number, and a user name and password that have been entered by a user. Instead of the username and password, any information uniquely identifying the user can be used. This can comprise any biometric input obtained by the client machine from the user e.g. fingerprint, retinal scans, handwriting recognition etc.

The present invention can be implemented by loading computer readable code onto any programmable device such as a general-purpose computer, a mobile device such as a mobile telephone, or an IP enabled consumer device to provide the client and the server. Thus, the present invention encompasses computer programme code on a carrier medium such as a storage medium (e.g. floppy disk, magnetic tape, CD ROM, or programmable memory device), or a transient medium such as an electrical, optical, microwave or radio frequency signal (e.g. an electrical signal carried over a network such as the Internet).

In the present invention, the client and the server can comprise a computer programme implemented on any suitable programmable device such as a general-purpose computer. It is thus possible for any combination of the target server, the secure server and the security server to reside on the same physical machine. It is however more preferable to provide these on separate physical machines to avoid any possibility of a hacker being able to bypass the secure means of communication between the service using the class C IP addresses in the specific embodiments.

An embodiment of the present invention will now be described with reference to the accompanying drawings, in which:

FIG. 1 is a schematic diagram of a prior art Internet client and server authentication process,

FIG. 2 is a diagram of an IP packet,

FIG. 3 is a flow diagram illustrating the prior art IP session authentication process,

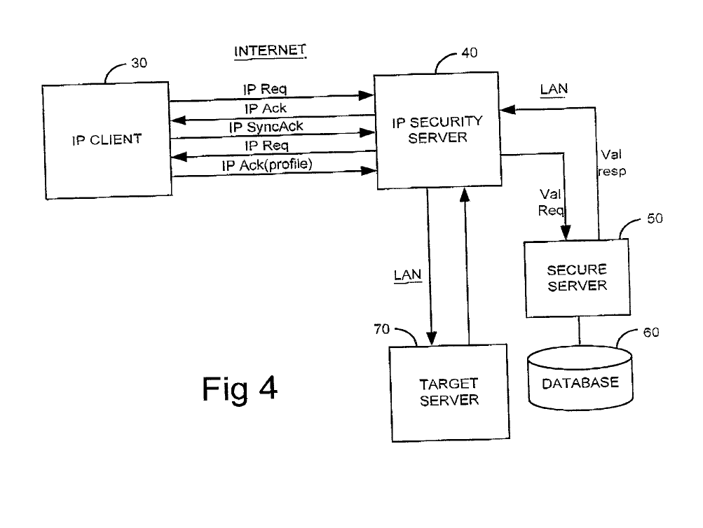

FIG. 4 is a schematic diagram of a system for provided secure access to a target server in accordance with an embodiment of the present invention,

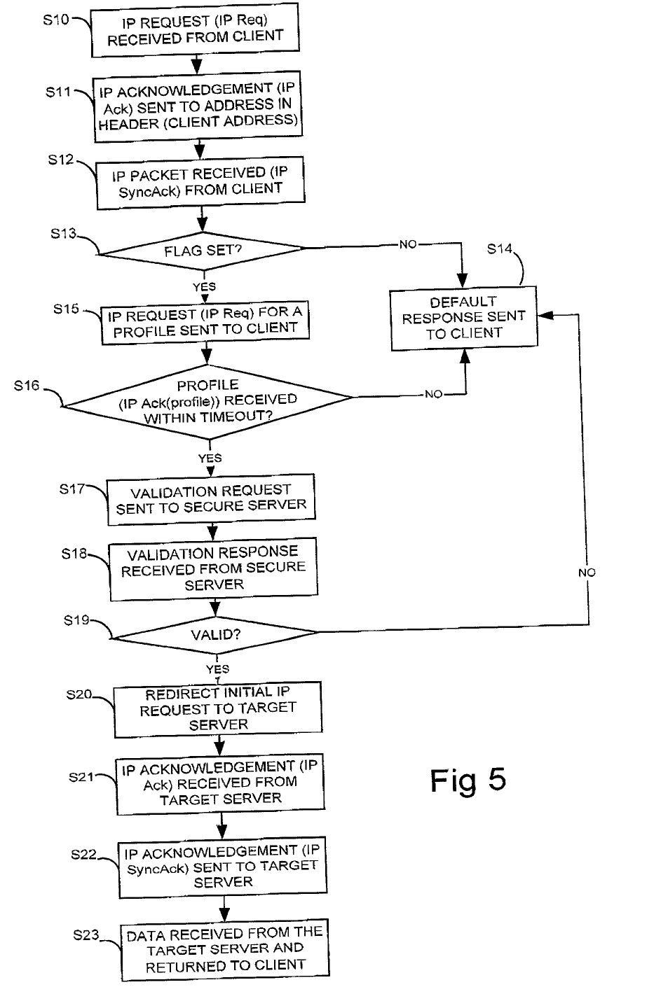

FIG. 5 is a flow diagram illustrating the functions performed by the security server,

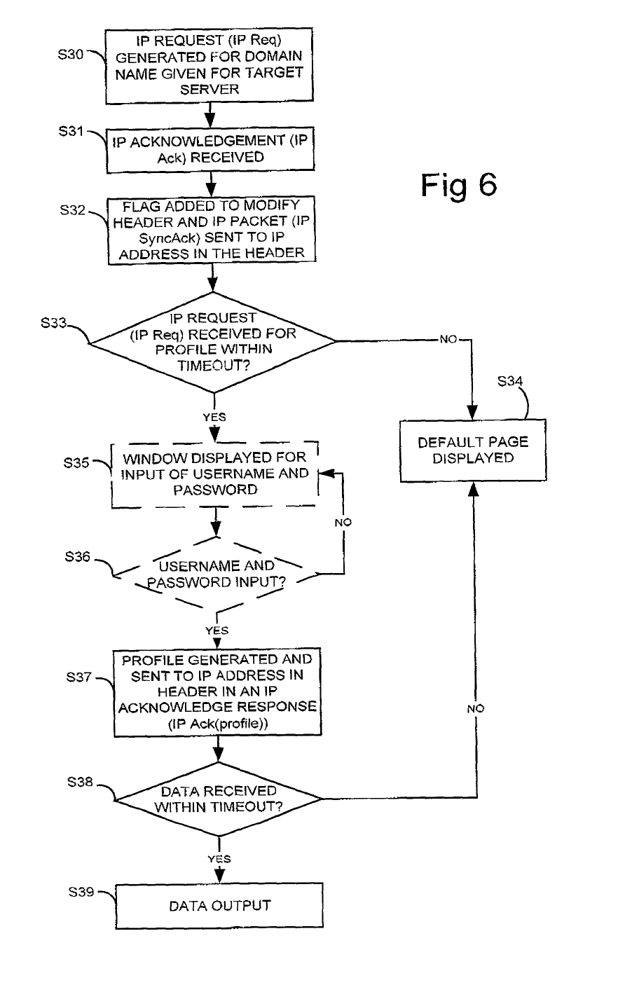

FIG. 6 is a flow diagram illustrating the functions performed by the client,

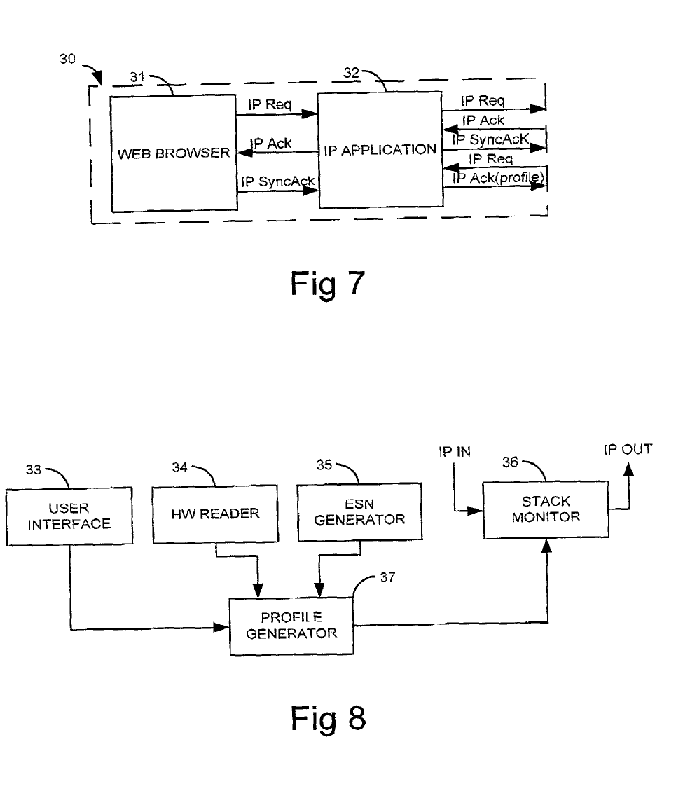

FIG. 7 is a schematic diagram of the functional components of the client,

FIG. 8 is a schematic diagram of functional code modules of the Internet protocol application in the client,

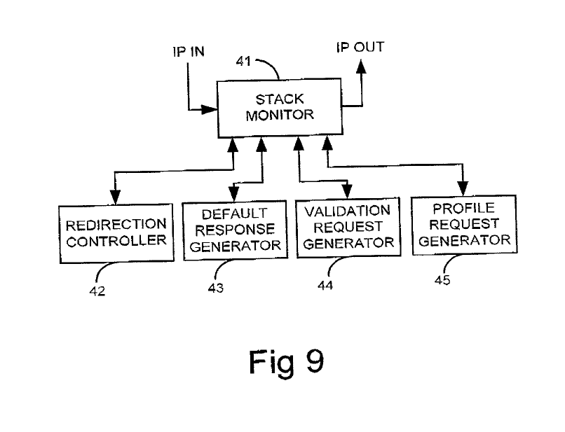

FIG. 9 is a schematic diagram of the functional code modules of the Internet protocol application in the security server,

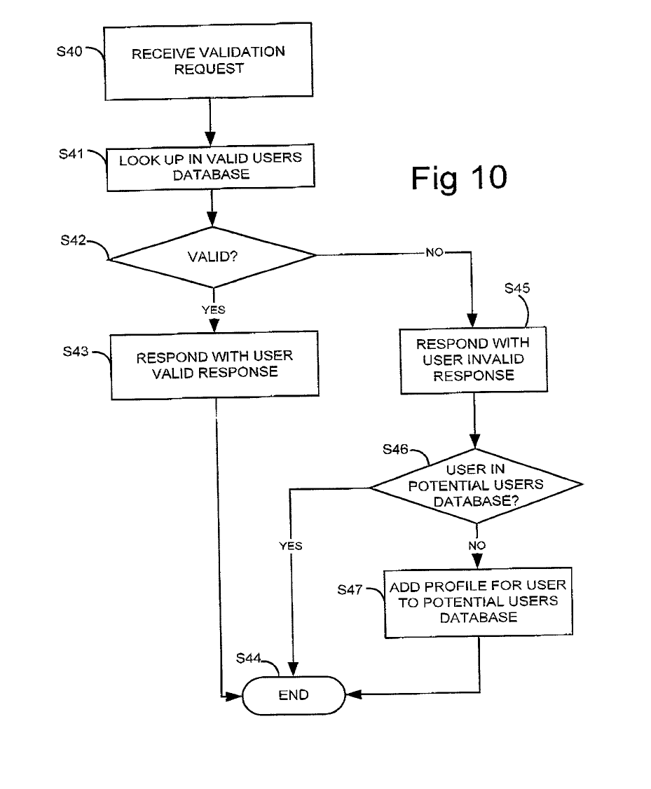

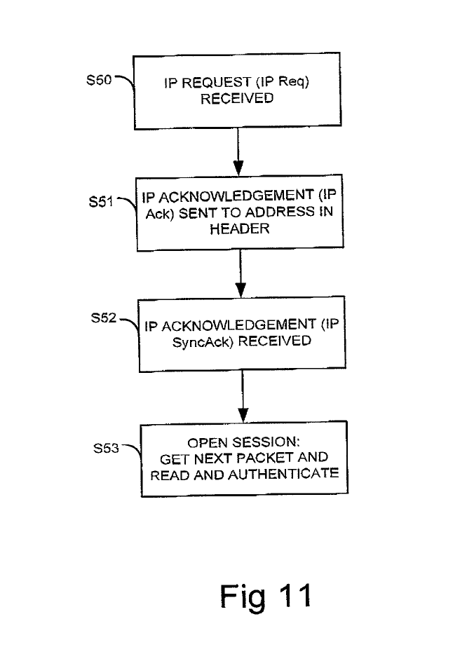

FIG. 10 is a flow diagram of the functions performed by the secure server, and FIG. 11 is a flow diagram of the functions performed by the target server.

The embodiment of the present invention will now be described with reference to FIGS. 4 to 11.

An IP client is connected over an IP network such as the Internet to an IP security server 40. The IP security server is connected via a local area network to a secure server 50 that is provided with a database 60. The security 40 is also connected over a local area network to a target server 70.

The security server 40 is connected to the Internet and is provided with a class A or B Internet address. This allows public access to the security server. The secure server 50 and the target server 70 on the other hand are connected over an IP network (LAN) to the security server 40 and have a class C IP address. A class C IP address lies between a range 192.168.0.0 and 255.255.255.255. Such IP addresses are only usable locally.

The operation of the security server 40 and the client will now be described in more detail with reference to the flow diagrams of FIGS. 5 and 6. In step S30 of FIG. 6 the client generates an IP request directed to the domain name given for the target server. This is sent over the IP network to a domain name server (DNS) that looks up the IP address given for the target server. The domain name server is however given instead of the class C address for the target server, the class A or B address for the security server. In this way all IP traffic for a target server is directed to the security server rather than to the target server. Thus in step S10 of FIG. 5 the security server receives the IP request from the client. In step S11 an IP acknowledgement is sent to the IP address given in the header of the IP packet. In step S31 of FIG. 6 the client receives the IP acknowledgement and in step S32 a flag is added to modify the header to indicate that the client has the capability to generate authentication information. The modified IP packet is then sent back in the received IP acknowledgement packet. The security server in step S12 receives this packet and in step S13 it is determined whether the flag in the packet header is set. If not, this indicates that the IP packet has not come from a client that is capable of providing authentication information and thus in step S14 a default response is sent to the client. This response can comprise a message that will be displayed at the client indicating that no data is available or access has been denied to the data requested.

If in step S13 the security server determines that the flag in the packet header has been set, in step S15 an IP request for a profile (authentication information) is sent to the client using the IP address obtained form the original IP request. The client waits in step S33 for a predetermined period for receipt of the IP request for the profile. If this request is not received within a predetermined period, in step S34 a default response is generated for display at the client. For example, a default web page can be generated and passed from the IP application in the client to the web browser for display of the default response.

If in step 33 it is determined that an IP request is received within the predetermined period of time, optionally a window can then be displayed to allow a user to input a user name and password in (step S35). The client then waits input of the user name and password (step S36). As an alternative to requiring the input of the user name and password at this point, the user name and password could be input “off line” as soon as the IP application is loaded before the machine is switched on.

At the client a profile is then generated using the input user name and password, unique identifying the hardware and/or software of the client machine such as the hard disk serial number, the Ethernet card serial number, the operating system serial number or the Bios serial number and an electronically generated serial number. The profile can be encrypted for additional security.

The security server waits to receive a profile from the client within a predetermined period of time in step Sl6. If the profile is not received in the predetermined period of time, in step S14, the default response is sent to the client.

If the profile is received within the predetermined period of time, in step S17 a validation request is sent to the secure server. The validation request carries the received profile and a request for authentication. The authentication process will be described in more detail hereinafter. The security server then receives a validation response from the secure server (step S18). If the validation response indicates that the profile is invalid (step S19) the security server sends a default response to the client (step S14). If the security server determines that the validation response indicates that the profile is valid (step S19), the initial IP request from the client is redirected by the security server to the target server (step S20). Thus in this process the security server simply acts as a router to modify the routing information in the header of the IP packet to pass the IP packet on to the target server. The target server then returns an IP acknowledgement to the security server (step S21) and the security server returns an IP sync acknowledgement to the target server (step S22) in the conventional authentication process. The IP session is thus established and in step S23 the data is received by the security server from the target server and this is sent to the client.

At the client, in step S38 data is awaited within a predetermined period of time. If no data is received from the target server within the predetermined period of time, a default response is displayed (step S34). If data is received within the predetermined period of time (step S38) the data is displayed (step S39). This is the typical behaviour of a web browser.

The functional structure of the client will now be described in more detail with reference to FIGS. 7 and 8. The client 30 can comprise any general-purpose computer that will implement computer programme code. In this embodiment the application requiring data from the target server is a web browser 31. Thus the protocol carried by the IP protocol is HTTP. Within the client 30 an IP application 32 monitors and modifies the flow of IP traffic between the web browser 31 and the IP network (Internet). Thus when the web browser generates the IP request this is passed by the IP application 32. When the IP acknowledgement is received it is also passed to the web browser 31. When the web browser acknowledgement response is output it is modified by the IP application 32 to include a flag to identify to the security server that there is an IP application 32 present on the client to generate and send a profile to allow authentication thus access to the target server. Thus when the security server responds with an IP request for the profile, this is received by the IP application 32 but not passed on to the web browser 31. The IP application 32 responds with an acknowledgement that carries a profile to the security server.

FIG. 8 is a functional diagram of the code provided in the IP application 32. The code to provide this functionality can be of any form or organisation. A user interface 33 is provided to enable a user to input a user name and password. A hardware reader 34 is provided to identify unique information about the hardware and/or software from the client machine such as the hard disk serial number, operating system serial number, BIOS serial number or any other information that uniquely identifies the configuration of the client machine. An electronic serial number generator 35 is also provided to generate an electronic serial number to further uniquely identify the client machine. A profile generator 37 receives the user name and password, the hardware and software information and the electronic serial number and uses this to generate a profile. The information can be encrypted within the generation of a profile.

A stack monitor 36 is provided to monitor the protocol stack within the computer. The stack monitor 36 is able to modify the acknowledgement generated to the security server by the client to indicate that the stack monitor 36 is present. When the request is received from the security server for the profile, the stack monitor is able to intercept this request and prevent it being passed to the web browser 31. In response the stack monitor 36 inserts the profile generated by the profile generator 37 into an IP packet or packets and return this as the acknowledgement to the security server.

The functional code structure of the security server will now be described in more detail with reference to FIG. 9. The code to provide this functionality can be of any form or organisation.

Within the security server there is provided a stack monitor 41 to monitor the flow of IP traffic into and out of the security server. When the stack monitor 41 detects a flag in an IP acknowledgement from a client, a profile request generator 45 can control the stack monitor 41 to request a profile from the client. When the profile is received, a validation request generator 44 can control the stack monitor 41 to send the profile together with the request for validation to the secure server 50. If no flag is set in the IP acknowledgement from the IP client, a profile is not received from the IP client, or the validation response from the secure server indicates the profile is invalid, a default response generator 43 can generate a default response that is sent to the client. The default response can either be a message or data. For example, the default response can comprise HTML for a web page, or simply a referral to another web site. This will cause the web browser within the client to display a web page, thus masking the fact that access has been denied to the target server.

If the validation response from the secure server is positive, a redirection controller 42 controls the stack monitor 41 to access the router to route the IP traffic between the client and the target server.

The operation of the secure server will now be described in more detail with reference to the flow diagram of FIG. 10.

In step S40 a secure server receives a validation request from the security server. The validation request caries the profile information and this is extracted from the request and decrypted where necessary. In step S41 the profile is used to look up in the valid user's database to determine whether the user is valid or not. If the user is valid (step S42) the secure server responds with a “valid user” response (step S43). If it is determined that the user is not valid (step S42), in step S45 the secure server will respond with a “user invalid” response. The secure server will then determine whether the user is already listed in a potential user's database. If not the profile is added to the potential user's database in step S47.

The storage of profiles for users in a potential user's database means that a fist time user to initially be denied access to the target server. An administrator of the secure server can however access the potential user's database and transfer the potential user to the valid user's database thus enabling the user to access the target server at the next attempt. It thus provides a very simple registration procedure under the control of the administrator. It also allows the user to select the username and password that they wish to use since this is the information that is entered in the profile that is initially entered in the potential user's database and then transferred to the valid user's database.

The operation of the target server will now be described in more detail with reference to the flow diagram of FIG. 11.

In step S50 the IP request originally from the client is received by the target server and in step S51 the target server generates an IP acknowledgement that is sent to the address in the IP packet header. In step S52 the security server responds with an acknowledgement that is received by the target server and thus in step S53 the IP session is open and the data carried by the IP packet is read and authenticated. Thus the target server is able to carry out further levels of authentication above the IP level protocol. For example, using HTTP, a CGI script could be run requiring the input of the user name and password for authentication to allow access to further web pages on the web site. This additional level of authentication that is conventional is provided on top of the IP protocol authentication provided by the present invention.

Although the present invention has been described hereinabove with reference to a specific embodiment, it will be apparent to a skilled person in the art that modifications to the embodiment lie within the spirit and scope of the present invention.

Although in the embodiment the security server implementing the security application is described as lying physically on a separate machine to the target server, it is however possible for the two server applications to be implemented on a single physical machine.

In such a case the security server and target server have the same IP address but will be given different ports.

It is also possible to incorporate the secure server in a single physical machine carrying the security server and/or the target server. In this case once again the secure server can be distinguished and communicated with using a different port. It is however preferable in the present invention to use separate physical machines to avoid the possibility that a hacker can bypass the security server to directly access the target server or the secure server.

In the embodiment of the present invention described hereinabove the profile obtained from the client machine uniquely identifies the machine (it comprises a hardware and software signature of the machine and user). The present invention encompasses any authentication information that enables the client machine or user to be uniquely identified. The user identification information can comprise biometric information input to the users machine. This can comprise fingerprint, retinal scans or handwriting for example to allow the user to be uniquely identified. This provides a higher level of security since the IP session will only be set up when both the machine and the user are uniquely identified and authorised.

Although in the embodiment described hereinabove in the IP network is described as comprising the Internet, the present invention can comprise any IP network such as a wireless network e.g. Bluetooth (trademark), GPRS, or Third Generation mobile network, an extranet, an intranet, an Ethernet, or any other Local Area Network. The physical architecture of the network and the lower level communication protocols used to provide the infrastructure for the IP network is immaterial to the present invention.

It will be apparent to the person skilled in the art that the clients and servers described in the embodiment of the present invention can comprise computer applications and can thus be embodied as software provided to any suitable programmable device such as a general purpose computer on any suitable carrier medium such as a storage medium e.g. floppy disk drive, hard disk drive, CD ROM or a signal such as an electronic signal carried over the Internet.

The security server acts as an intermediate server between the client and the target server. Because the security server contains no data that is accessible by the client, security is ensured. The physical separation of the secure server ensures that sensitive information enabling access to the target server is remote from the security server thus preventing access to the information by a hacker.

In the present invention, a device generates an IP request directed to an IP address for a service. The service has however given the IP address to an intermediary service to act as a security filter for the service. Thus the device initially contacts the intermediary where an authentication process takes place. If the authentication process is successful, the IP request is passed on to the service for fulfilment of the request. In this way the service is shielded from unauthorised attacks.

The present invention has been described with reference to the Internet Protocol since this is the routing layer datagram protocol that is presently widely used. However, the present invention is applicable to any equivalent layer 3 protocol i.e. any packet routing layer protocol which enable not only point-to-point routing of packets but also broadcasting and multicasting of packets between clients and servers.

1. A secure communication method, comprising
generating an Internet Protocol request from a client apparatus destined for a target server;
receiving the Internet Protocol request at an intermediate server;
sending an Internet Protocol request for authentication information from the intermediate server to the client apparatus;
sending the requested authentication information from the client apparatus to the intermediate server;
performing a validation check on the authentication information; and
transparently passing on the Internet Protocol request from the client apparatus to the target server and returning data from the target server to the client apparatus dependent upon the outcome of the validation.

2. A secure communication method according to claim 1 wherein the received Internet Protocol request is acknowledged by the intermediate server to the client apparatus, the client apparatus responds with an acknowledgement including an identifier that the client apparatus may be authorised to access the target server, the request for authentication information is only sent when the identifier is received by the intermediate server, and a default response is sent by the intermediate server to the client apparatus if the identifier is not received by the intermediate server.

3. A secure communication method according to claim 2 wherein the default response is a message that data requested by the Internet Protocol request was not found.

4. A secure communication method according to claim 2 wherein the default response is default data.

5. A secure communication method according to claim 1 wherein the target server has a class 3 Internet Protocol address and Internet Protocol communication between the intermediate server and the target server is over a local area network.

6. A secure communications method according to claim 1 wherein the validation is performed at a validation server upon a validation request from the intermediate server.

7. A secure communication method according to claim 6 wherein the secure server has a class 3 Internet Protocol address and Internet Protocol communication between the intermediate server and the secure server is over a local area network.

8. A secure communication method according to claim 6 wherein the secure server includes a database of authorised users for the performance of the validation.

9. A secure communication method according to claim 8 wherein the secure server also includes a potential users database if the validation procedure is unsuccessful the received authentication information is entered in the potential users database, and an administrator can transfer the authentication information for a user from the potential users database to the valid users database.

10. A secure communication method according to claim 1 wherein the Internet Protocol request is generated with the domain name given for the target server, and the domain name is converted to the Internet Protocol address of the intermediate server by a Domain Name Server.

11. A secure communication method according to claim 10 wherein the Internet Protocol address of the intermediate server is a class A or B address.

12. A secure communications method according to claim 1 wherein the authentication information includes client apparatus information uniquely identifying hardware and/or software of the client apparatus.

13. A secure communication method according to claim 1 wherein the authentication information includes an electronically generated serial number.

14. A secure communication method according to claim 1 wherein a user of the client apparatus enters a username and password and the authentication information includes the username and password.

15. A secure communication method according to claim 1, wherein if the validation procedure fails a default response is sent to the client apparatus by the intermediate server.

16. A secure communication method according to claim 14 wherein the default response is default data.

17. A secure communication method according to claim 15 wherein the default response is a message tat data requested by the Internet Protocol request was not found or available or that access id denied.

18. A secure communication method according to claim 1 wherein if no authentication information is received within a predetermined time period by the intermediate server from the client apparatus, a default response is sent to the client apparatus by the intermediate server.

19. A secure communication method according to claim 18 wherein the default response is a message that data requested by the Internet Protocol request was not found or available or that access is denied.

20. A secure communication method according to claim 18 wherein the default response is default data.

21. A secure communication system comprising:
a client apparatus having an application for generating an Internet Protocol request destined for a target server, and an authentication application for sending authentication information to an intermediate server; and
an intermediate server having an application for receiving the Internet Protocol request, for sending an Internet Protocol request for authentication information to the client apparatus, for receiving authentication information, for performing a validation process for the authentication information, and for transparently passing on the Internet Protocol request from the client apparatus to the target server and returning data from the target server to the client apparatus dependent upon the outcome of the validation process.

22. A secure communication system, according to claim 21 wherein the application of the intermediate server is operative to acknowledge the received Internet Protocol request to the client apparatus; the application of the client apparatus is operative to respond with an acknowledgement including an identifier that the client apparatus may be authorised to access the target server; and the application of the intermediate server is operative to only send the request for authentication information when the identifier is received by the intermediate server; and to send a default response to the client apparatus if the identifier is not received.

23. A secure communication system according to claim 22 wherein the default response is a message that data requested by the Internet Protocol request was not found or available or that access is denied.

24. A secure communication system according to claim 22 wherein the default response is default data.

25. A secure communication system according to claim 21 wherein the target server has a class 3 Internet Protocol address and Internet Protocol communication between the intermediate server and the target server is over a local area network.

26. A secure communication system according to claim 21 including a validation server, for receiving a validation request from the intermediate server for performing a validation check and for sending a validation result to the intermediate server, wherein the application of the intermediate server is operative to perform the validation process by sending the validation request to the validation server and receiving the validation result.

27. A secure communication system according to claim 26 wherein the secure server has a class 3 Internet Protocol address and Internet Protocol communication between the intermediate server and the secure server is over a local area network.

28. A secure communication system according to claim 26 wherein the secure server includes a database of authorised users for the performance of the validation.

29. A secure communication system according to claim 28 wherein the secure server also includes a potential uses database; the secure server being operative, if the validation check is unsuccessful, to enter the received authentication information in the potential users database; the secure server also including an administrator interface to allow an administrator to transfer the authentication information for a user from the potential users database to the valid users database.

30. A secure communication system according to claim 21, wherein the application of the client apparatus is operative to generate the Internet Protocol request with the domain name given for the target server, and the domain name is converted to the Internet Protocol address of the intermediate server by a Domain Name Server.

31. A secure communication system according to claim 30 wherein the Internet Protocol address of the intermediate server is a class A or B address.

32. A secure communication system according to claim 21 wherein the authentication information includes client apparatus information uniquely identifying hardware and/or software of the client apparatus.

33. A secure communication system according to claim 21 wherein the authentication information includes an electronically generated serial number.

34. A secure communication system according to claim 21 wherein the client apparatus receives a username and password from a user and the authentication information includes the username and password.

35. A secure communication system according to claim 21 wherein the application of the intermediate server is operative to, if the validation process is negative, send a default response to the client apparatus.

36. A secure communication system according to claim 35 wherein the default response is default data.

37. A secure communication system according to claim 35 wherein the default response is a message that data requested by the Internet Protocol request was not found or available or that access is denied.

38. A secure communication system according to claim 21 wherein the authentication server is operative to, if no authentication information is received within a predetermined period of time from the client apparatus, send a default response to the client apparatus.

39. A secure communication system according to claim 38 wherein the default response is a message that data requested by the Internet Protocol request was not found or available or that access is denied.

40. A secure communication system according to claim 38 wherein the default response is default data.

41. A server apparatus for providing secure communication over a communications network using Internet Protocol, to a target server from a client apparatus, the server apparatus comprising:
an interface for connecting the client apparatus over the network for receiving an Internet Protocol request from the client apparatus destined for the target server, for sending a request for authentication information to the client apparatus, and for receiving the requested authentication information;
validation means for performing a validation process for the authentication information; and
routing means for passing on the Internet Protocol request from the client apparatus to the target server and returning data from the target server to the client apparatus dependent upon the outcome of the validation process.

42. A server apparatus according to claim 41 wherein said interface is adapted to acknowledge the received Internet Protocol request to the client apparatus, to receive an acknowledgement from the client apparatus, including an identifier that the client apparatus may be authorised to access the target server, and to send to the client apparatus the request for authentication information when the identifier is received or a default response when the identifier is not received.

43. A server apparatus according to claim 42 wherein the default response is a message that data requested by the Internet Protocol request was not found or available or that access is denied.

44. A server apparatus according to claim 42 wherein the default response is default data.

45. A server apparatus according to claim 41 wherein said routing means includes a local area network interface for communication with the target server using a class 3 Internet Protocol address for the target server.

46. A server apparatus according to claim 41 wherein the validation means is operative to send a validation request to a validation server and to receive a validation result.

47. A server apparatus according to claim 46 wherein the validation means includes a local area network interface means for communication with the secure server using a class 3 Internet Protocol address for the secure server.

48. A server apparatus according to claim 41 wherein the interface has a class A or B Internet Protocol Address.

49. A server apparatus according to claim 41 wherein the interface is adapted to send a default response to the client apparatus if the validation process is unsuccessful.

50. A server apparatus according to claim 49 wherein the default response is a message that data requested by the Internet Protocol request was not found or available or that access is denied.

51. A server application according to claim 49 wherein the default response is default data.

52. A server apparatus according to claim 41 wherein the interface is adapted to send a default response to the client apparatus if not authentication information is received within a predetermined time period.

53. A server apparatus according to claim 52 wherein the default response is a message that data requested by the Internet Protocol request was not found or available or that access is denied.

54. A server apparatus according to claim 52 wherein the default response is default data.

55. A method of operating a security server for providing secure access to a target server by a client apparatus over a communication network using Internet Protocol, the method comprising:
receiving an Internet Protocol request from the client apparatus destined for the target server;
sending an Internet Protocol request for authentication information to the client apparatus;
receiving the requested authentication information;
performing a validation process for the authentication information; and
passing on the Internet Protocol request from the client apparatus to the target server and returning data from the target server to the client apparatus dependent upon the outcome of the validation process.

56. A method according to claim 55 including acknowledging the received Internet Protocol request to the client apparatus, receiving an acknowledgement from the client apparatus including an identifier that the client apparatus may be authorised to access the target server, and sending to the client apparatus the request for authentication information when the identifier is received or a default response when the identifier is not received.

57. A method according to claim 56 wherein the default response is a message that data requested by the Internet Protocol request was not found or available or that access is denied.

58. A method according to claim 56 wherein the default response is default data.

59. A method according to claim 55 wherein the target server has a class 3 Internet Protocol address and Internet Protocol communication with the target server are made using a local area network.

60. A method according to claim 55 wherein the validation process comprises sending a validation request to a validation server and receiving a validation result from the validation server.

61. A method according to claim 60 wherein the secure server has a class 3 Internet Protocol address and Internet Protocol communications with the secure server are made using a local area network.

62. A method according to claim 55 wherein Internet Protocol address used for the security server for Internet Protocol communications with the client apparatus is a class A or B address.

63. A method according to claim 55 wherein a default response is sent to the client apparatus if the validation process is unsuccessful.

64. A method according to claim 63 wherein the default response is a message that data requested by the Internet Protocol request was not found or available or that access is denied.

65. A method according to claim 63 wherein the default response is default data.

66. A method according to claim 55 wherein a default response is sent to the client apparatus if no authentication information is received within a predetermined time period.

67. A method according to claim 66 wherein the default response is a message that data requested by the Internet Protocol request was not found or available or that access is denied.

68. A method according to claim 66 wherein the default response is default data.

69. A security server for providing secure access to a target server by a client over an Internet Protocol network, the server comprising;
an Internet Protocol interface for connection to the client over said network;
an interface for connection to said target server;
program memory for storing program code for controlling a processor; and
a processor for implementing the stored program code, to control the interface;
wherein the program code comprises code to control the processor to:
receive an Internet Protocol request from the client destined for the target server;
send an Internet Protocol request for authentication information to the client;
receive the requested authentication information;
perform a validation process for the authentication information; and
pass on the Internet Protocol request from the client to the target server and return data from the target server to the client dependent upon the outcome of the validation process.

70. A client apparatus for gaining a validated access to data at a target server over an Internet Protocol network, the client apparatus comprising:
an interface to the Internet Protocol network for sending an Internet Protocol request destined for the target server, for receiving an Internet Protocol request for authentication information from a security server, and for sending the requested authentication information to the security server using the Internet Protocol; and
authentication means for generating the authentication information;
wherein the interface is arranged to receive data from the target server if authentication of the authentication information is successful.

71. A client apparatus according to claim 70 wherein the authentication means is adapted to generate the authentication information to include information uniquely identifying hardware and/or software of the client apparatus.

72. A client apparatus according to claim 70 wherein the authentication means is adapted to generate the authentication information to include an electronically generated serial number.

73. A client apparatus according to claim 70 including user interface means for allowing a user to input a username and a password, wherein the authentication means is adapted to generate the authentication information to include the username and password.

74. A client apparatus according to claim, 70 including an application for generating the Internet Protocol request and for using received data, wherein the interface includes means for monitoring and modifying Internet Protocol packets passing between the Internet Protocol network and the application.

75. A method of controlling a client apparatus for gaining a validated access to data at a target server over an Internet Protocol network, the method comprising:
sending an Internet Protocol request destined for the target server;
receiving an Internet Protocol request for authentication information from a security server;
generating authentication information;
sending the authentication information to the security server using the Internet Protocol; and
receiving data from the target server if authentication of the authentication information is successful.

76. A method according to claim 75 wherein the authentication information is generated to include information uniquely identifying hardware and/or software of the client apparatus.

77. A method according to claim 75 wherein the authentication information is generated to include an electronically generated serial number.

78. A method according to claim 75 wherein a username and a password are input, and the authentication information is generated to include the username and password.

79. A method according to claim 75 including generating an Internet Protocol request using an application, and Internet Protocol packets passing between the Internet Protocol network and the application are monitored and modified to send the requested authentication information to the security server.

80. A carrier medium carrying computer readable code for controlling a processing apparatus to implement the method of any one of claims 55 to 68 or 75 to 79.

81. A secure communication method, comprising
generating an packet routing layer protocol request from a client destined for a target server;
receiving the packet routing layer protocol request at an intermediate server;
sending an packet routing layer protocol request for authentication information from the intermediate server to the client;
sending the requested authentication information from the client to the intermediate server;
performing a validation check on the authentication information; and
transparently passing on the packet routing layer protocol request from the client to the target server and returning data from the target server to the client in dependence upon the outcome of the validation.

82. A secure communication system comprising:
a client having an application for generating a packet routing layer protocol request destined for a target server, and an authentication application for sending authentication information to an intermediate server; and
an intermediate server having an application for receiving the packet routing layer protocol request, for sending an packet routing layer protocol request for authentication information to the client, for receiving authentication information, for performing a validation process for the authentication information, and for transparently passing on the packet routing layer protocol request from the client to the target server and returning data from the target server to the client dependent upon the outcome of the validation process.

83. A server for providing secure communication over a communications network using a packet routing layer protocol, to a target server from a client, the server comprising:
an interface for connecting the client over the network for receiving an packet routing layer protocol request from the client destined for the target server, for sending a request for authentication information to the client, and for receiving the requested authentication information;
validation means for performing a validation process for the authentication information; and
routing means for passing on the packet routing layer protocol request from the client to the target server and returning data from the target server to the client in dependence upon the outcome of the validation process.

84. A security server for providing secure access to a target server by a client over a packet routing layer protocol network, the server comprising:
a packet routing layer protocol interface for connection to the client over said network;
an interface for connection to said target server;
program memory for storing program code for controlling a processor; and
a processor for implementing the stored program code, to control the interface;
wherein the program code comprises code to control the processor to:
receive an packet routing layer protocol request from the client destined for the target server;
send an packet routing layer protocol request for authentication information to the client;
receive the requested authentication information;
perform a validation process for the authentication information; and
pass on the packet routing layer protocol request from the client to the target server and return data from the target server to the client dependent upon the outcome of the validation process.

85. A client for gaining a validated access to data at a target server over a network using a packet routing layer protocol, the client comprising:
an interface to the network for sending an packet routing layer protocol request destined for the target server, for receiving an packet routing layer protocol request for authentication information from a security server, and for sending the requested authentication information to the security server using the packet routing layer protocol; and
authentication means for generating the authentication information;
wherein the interface is arranged to receive data from the target server if authentication of the authentication information is successful.

86. A method of operating a security server for providing secure access to a target server by a client over a communication network using a packet routing layer protocol, the method comprising:
receiving a packet routing layer protocol request from the client destined for the target server;
sending a packet routing layer protocol request for authentication information to the client;
receiving the requested authentication information;
performing a validation process for the authentication information; and
passing on the packet routing layer protocol request from the client to the target server and returning data from the target server to the client dependent upon the outcome of the validation process.

87. A method of controlling a client for gaining a validated access to data at a target server over a network using a packet routing layer protocol, the method comprising:
sending an packet routing layer protocol request destined for the target server;
receiving an packet routing layer protocol request for authentication information from a security server;
generating authentication information;
sending the authentication information to the security server using the packet routing layer protocol; and
receiving data from the target server if authentication of the authentication information is successful.

88. A carrier medium carrying computer readable code for controlling a processing apparatus to implement the method of any one of claims 81, 86 or 87.
